(19) United States
(12) Patent Application Publication
(10) Pub. No.: US 2023/0195640 A1
(43) Pub. Date: Jun. 22, 2023

(54) Cache Associativity Allocation

(71) Applicant: Advanced Micro Devices, Inc., Santa Clara, CA (US)

(72) Inventor: Jeffrey Christopher Allan, Billerica, MA (US)

(73) Assignee: Advanced Micro Devices, Inc., Santa Clara, CA (US)

(21) Appl. No.: 17/557,731

(22) Filed: Dec. 21, 2021

(51) Int. Cl. G06F 12/0893; G06F 12/0864

(52) U.S. Cl. CPC G06F 12/0893; G06F 12/0864; G06F 2212/604

(57) ABSTRACT

Cache associativity allocation is described. In accordance with the described techniques, a portion of associativity of a cache is allocated to a category of cache requests. The portion of associativity corresponds to a subset of cachelines of the cache. A request is received to access the cache, and a cacheline of the subset of cachelines is allocated to the request based on a category associated with the request. Data corresponding to the request is loaded into the cacheline of the subset of cachelines.

### BACKGROUND

A cache is a hardware or software component that stores data (at least temporarily) so that a future request for the data is served faster than it would be if the data were served from main memory. A “cache hit” occurs when requested data can be found in the cache, while a “cache miss” occurs when requested data cannot be found in the cache. A cache miss occurs, for example, in scenarios where the requested data has not yet been loaded into the cache or when the requested data was evicted from the cache prior to the request. A cache replacement policy defines rules for selecting one of the cachelines of the cache to evict so that requested data can be loaded into the selected cacheline responsive to a cache miss.

### BRIEF DESCRIPTION OF THE DRAWINGS

The detailed description is described with reference to the accompanying figures.

FIG. 1 is a block diagram of a non-limiting example system having a cache and a controller with an associativity allocator according to some implementations.

FIG. 2 depicts a non-limiting example in which an associativity allocator allocates a portion of associativity of the cache to a category of cache requests.

FIG. 3 depicts a non-limiting example in which a tree structure of a cache replacement policy is traversed according to a traversal algorithm of the cache replacement policy to select cachelines.

FIG. 4 depicts a non-limiting example of an implementation in which the cache replacement policy is modified to allocate a portion of associativity of the cache to a category of cache requests.

FIG. 5 depicts a procedure in an example implementation of allocating a portion of associativity of a cache to a category of cache requests.

FIG. 6 depicts a procedure in an example implementation of dividing associativity of a cache and allocating portions of associativity of the cache to different categories of cache requests.

### DETAILED DESCRIPTION

Overview

Associativity of a cache defines a set of cachelines of the cache that data is permitted to be loaded into responsive to a cache miss. A cache that is “fully associative,” for example, permits data to be loaded into any cacheline of the cache. A fully associative cache, however, can be dominated by a particular workload with a high volume of requests to the cache, making it difficult for other workloads to utilize the cache.

To solve this problem, cache associativity allocation is described herein. The described techniques allocate portions of associativity of the cache to different categories of cache requests, such as by allocating a first portion of the associativity to a first category of cache requests and a second portion of the associativity to a second category of cache requests. The different categories, for example, correspond to different workloads or threads executed by a cache client. For instance, a first category is associated with requests corresponding to a first workload and a second category is associated with requests corresponding to a second workload. A portion of the associativity of the cache is allocated to a particular category of cache requests by reserving a subset of cachelines of the cache for the particular category, such that data associated with cache requests of the category are loaded into the reserved subset of cachelines, e.g., responsive to a cache miss.

In one or more implementations, a cache replacement policy that controls loading data into the cache responsive to a cache miss includes a binary tree with leaf nodes corresponding to cachelines of the cache and also includes a pseudo least recently used algorithm that is utilized to traverse the binary tree to select a cacheline to evict responsive to a cache miss. To allocate portions of the associativity of the cache to the categories, in this implementation, the pseudo least recently used algorithm is modified by “locking,” or otherwise setting, the traversal direction indicator of a node of the binary tree in a first direction for a first category of requests (e.g., left) and a second direction for a second category of requests (e.g., right). In this way, the first category of cache requests is limited to loading data into cachelines corresponding to the leaf nodes oriented to the left of the locked node of the binary tree, while the second category of cache requests is limited to loading data into cachelines corresponding to the leaf nodes oriented to the right of the locked node of the binary tree.

By allocating portions of the associativity of the cache to different categories of cache requests, the described techniques limit which cachelines data is permitted to be loaded into based on a category of the request associated with the data, e.g., a workload to which the request corresponds. By further limiting which cachelines that data is permitted to be loaded into based on category, the described techniques prevent a particular category of cache requests from dominating use of all the cachelines of the cache, which is otherwise permitted by conventional cache replacement policies.

In some aspects, the techniques described herein relate to a method including: allocating a portion of associativity of a cache to a category of cache requests, the portion of associativity corresponding to a subset of cachelines of the cache; receiving a request to access the cache; and allocating a cacheline of the subset of cachelines to the request based on a category associated with the request, and loading data corresponding to the request into the cacheline of the subset of cachelines.

In some aspects, the techniques described herein relate to a method, wherein the allocating the portion of the associativity includes locking traversal of at least one node of a tree structure in a direction, the tree structure traversed to identify which cachelines to allocate to requests, and the traversal being locked in the direction for requests associated with the category.

In some aspects, the techniques described herein relate to a method, further including allocating an additional portion of the associativity of the cache to an additional category of cache requests, the additional portion of the associativity allocated by locking the traversal of the at least one node of the tree structure in a different direction for requests associated with the additional category.

In some aspects, the techniques described herein relate to a method, wherein the tree structure is a binary tree that is traversed according to a pseudo least recently used algorithm to identify which cachelines to allocate to the requests.

In some aspects, the techniques described herein relate to a method, further including allocating the cacheline of the subset of cachelines, and loading the data corresponding to the request by traversing the tree structure.

In some aspects, the techniques described herein relate to a method, further including: allocating an additional portion of the associativity of the cache to an additional category of cache requests, the additional portion of associativity corresponding to an additional subset of cachelines of the cache; receiving an additional request associated with the additional category to access the cache; and allocating a cacheline of the additional subset of cachelines to the additional request and loading additional data corresponding to the additional request into the cacheline of the additional subset of cachelines.

In some aspects, the techniques described herein relate to a method, wherein the category corresponds to a first workload or thread and wherein the additional category corresponds to a second workload or thread.

In some aspects, the techniques described herein relate to a method, further including determining that the category associated with the request corresponds to the category of cache requests.

In some aspects, the techniques described herein relate to a method, wherein the category of cache requests is associated with at least one of: a workload or thread of with the cache requests; an originator of the cache requests; a destination of the cache requests; or characteristics of the cache requests.

In some aspects, the techniques described herein relate to a method, wherein allocating the portion of associativity of the cache to the category of cache requests occurs responsive to a trigger event, the trigger event including one of: launching an application; initializing a workload or thread; or determining that usage of the cache exceeds a threshold usage.

In some aspects, the techniques described herein relate to a method, wherein the data corresponding to the request is obtained from a data store.

In some aspects, the techniques described herein relate to a method, wherein the data store includes a virtual memory.

In some aspects, the techniques described herein relate to a system including: a cache divided into cachelines; and a controller to: allocate a portion of associativity of the cache to a category of cache requests, the portion of associativity corresponding to a subset of the cachelines; and allocate a cacheline of the subset of cachelines to a request based on a category of the request, and load data corresponding to the request into the cacheline of the subset of cachelines.

In some aspects, the techniques described herein relate to a system, wherein the controller allocates the portion of associativity of the cache by locking traversal of at least one node of a tree structure in a direction, the tree structure traversed to identify which cachelines to allocate to requests, and the traversal being locked in the direction for requests associated with the category.

In some aspects, the techniques described herein relate to a system, wherein the controller is further configured to allocate an additional portion of the associativity of the cache to an additional category of cache requests, the additional portion of the associativity allocated by locking the traversal of the at least one node of the tree structure in a different direction for requests associated with the additional category.

In some aspects, the techniques described herein relate to a system, wherein the tree structure is a binary tree that is traversed according to a pseudo least recently used algorithm to identify which cachelines to allocate to the requests.

In some aspects, the techniques described herein relate to a system, wherein the cache is connected to an external memory.

In some aspects, the techniques described herein relate to a system, wherein the system includes a server, a personal computer, or a mobile device.

In some aspects, the techniques described herein relate to a method including: dividing associativity of a cache into at least a first portion and a second portion; allocating the first portion of the associativity of the cache to a first category of cache requests, the allocating limiting the first category of cache requests to loading data using the first portion of the associativity of the cache responsive to a cache miss; and allocating the second portion of the associativity of the cache to a second category of cache requests, the allocating limiting the second category of cache requests to loading data using the second portion of the associativity of the cache responsive to a cache miss.

In some aspects, the techniques described herein relate to a method, wherein: the allocating the first portion of associativity of the cache to the first category of cache requests permits the first category of cache requests to access both the first portion and the second portion of associativity of the cache but prevents the first category of cache requests from loading data using the second portion of associativity of the cache responsive to the cache miss; and the allocating the second portion of associativity of the cache to the second category of cache requests permits the second category of cache requests to access both the first portion and the second portion of associativity of the cache but prevents the second category of cache requests from loading data using the first portion of associativity the cache responsive to the cache miss.

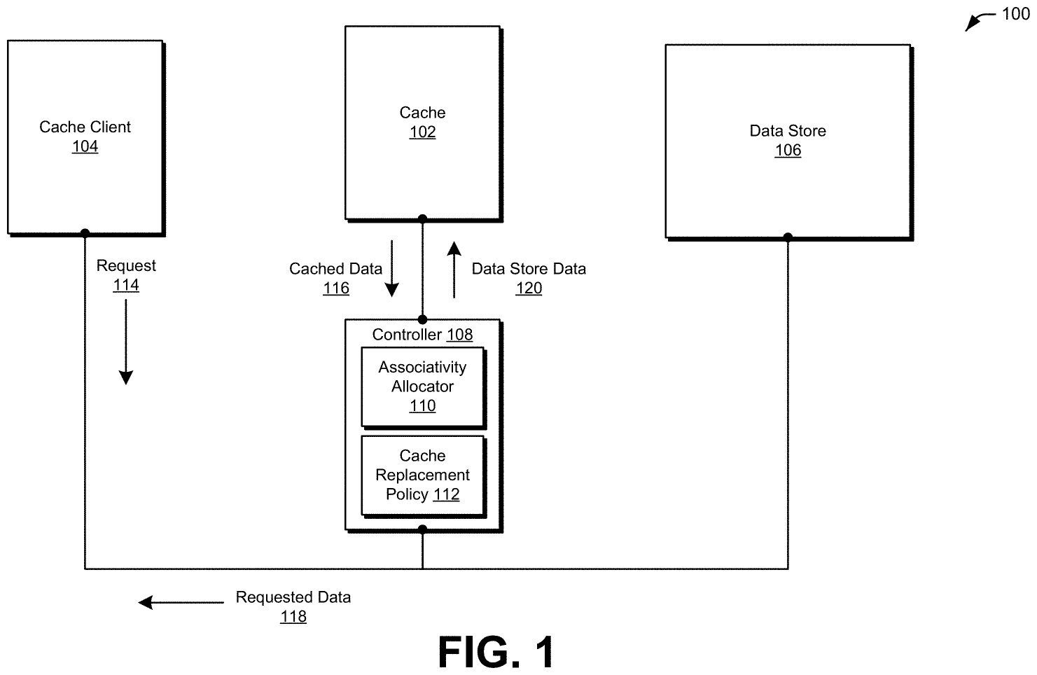

FIG. 1 is a block diagram of a non-limiting example system 100 having a cache and a controller with an associativity allocator according to some implementations. In particular, the system includes cache 102, cache client 104, data store 106, and controller 108, which includes associativity allocator 110 and cache replacement policy 112. In accordance with the described techniques, the cache 102 the cache client 104, and the data store 106 are coupled to one another via a wired or wireless connection. Example wired connections include, but are not limited to, buses connecting two or more of the cache 102, the cache client 104, and the data store 106. Examples of system 100 include, by way of example and not limitation, personal computers, laptops, desktops, servers, game consoles, set top boxes, tablets, smartphones, mobile devices, and other computing devices.

The cache 102 is a hardware or software component that stores data (e.g., at least temporarily) so that a future request for the data is served faster from the cache 102 than from the data store 106. In one or more implementations, the cache 102 is at least one of smaller than the data store 106, faster at serving data to the cache client 104 than the data store 106, or more efficient at serving data to the cache client 104 than the data store 106. Additionally or alternatively, the cache 102 is located closer to the cache client 104 than is the data store 106. It is to be appreciated that in various implementations the cache 102 has additional or different characteristics which make serving at least some data to the cache client 104 from the cache 102 advantageous over serving such data from the data store 106.

In one or more implementations, the cache 102 is a memory cache, such as a particular level of cache (e.g., L1 cache) where the particular level is included in a hierarchy of multiple cache levels (e.g., L0, L1, L2, L3, and L4). In some variations, the cache 102 is a hardware component built into and used by the cache client 104. In other examples, the cache 102 is implemented at least partially in software, such as in at least one scenario where the cache client 104 is a web browser or a web server. The cache 102 is also implementable in different ways without departing from the spirit or scope of the described techniques.

The cache client 104 is a component that requests access to data for performing one or more operations in relation to such data. Examples of the cache client 104 include, but are not limited to, a central processing unit, a parallel accelerated processor (e.g., a graphics processing unit), a digital signal processor, a hardware accelerator, an operating system, a web browser, a web server, an application, and a lower-level cache (e.g., a lower-level in a cache hierarchy than the cache 102), to name just a few.

In various implementations, the cache client 104 provides a request 114 for access to data. By way of example, the request 114 is a request for write access to the data or a request for read access to the data. In accordance with the described techniques, the request 114 is received to access the cache to attempt to find the data in the cache 102. For example, the request 114 is received by the controller 108. Responsive to the request 114, for instance, the controller 108 searches the cache 102 to determine if the data is stored in the cache 102. If, by searching the cache 102, the controller 108 identifies that the data is stored in the cache 102, then the controller 108 provides access to the data in the cache 102. As described herein, a “cache hit” occurs when the controller 108 can identify that the data, identified by the request 114, is stored in the cache 102. When the request 114 is for write access, on a cache hit, the controller 108 modifies (e.g., updates) the data in the cache 102 that is identified by the request 114. When the request 114 is for read access, on a cache hit, the controller 108 retrieves the data in the cache 102 that is identified by the request 114. In the illustrated example, data retrieved from the cache 102 based on the request 114 is depicted as cached data 116. The controller 108 provides the cached data 116 to the cache client 104.

The illustrated example also depicts requested data 118. The requested data 118 corresponds to the data provided to the cache client 104 responsive to the request 114. When the data identified in the request 114 is served from the cache 102, on a cache hit for example, the requested data 118 corresponds to the cached data 116. In one or more scenarios, though, the data identified in the request 114 is served from the data store 106. In a scenario where the data is not found in the cache 102 and is flagged as being stored in a non-cacheable location of the data store 106, for instance, the requested data 118 corresponds to the data provided to the cache client 104 from the data store 106. As described herein, a “cache miss” occurs when the controller 108 does not identify the data, identified by the request 114, in the cache 102. A cache miss occurs, for example, when the data identified by the request 114 has not yet been loaded into the cache 102 or when the data identified by the request 114 was evicted from the cache 102 prior to the request 114.

In various scenarios, the controller 108 loads the data identified by the request from the data store 106 into the cache 102 responsive to a cache miss. In the illustrated example, data retrieved from the data store 106 and loaded into the cache 102 is depicted as data store data 120. When a cache miss is determined, for instance, the data requested by the request 114 is identified in the data store 106 and is loaded from the data store 106 into one or more “locations” in the cache 102, e.g., into one or more cachelines of the cache 102. This enables future requests for the same data to be served from the cache 102 rather than from the data store 106. As discussed in more detail below, the controller 108 loads the data from the data store 106 (e.g., the data store data 120) into the cache 102 based on at least one of the associativity allocator 110 or the cache replacement policy 112.

In accordance with the described techniques, the data store 106 is a computer-readable storage medium that stores data. Examples of the data store 106 include, but are not limited to, main memory (e.g., random access memory), an external memory, a higher-level cache (e.g., L2 cache when the cache 102 is an L1 cache), secondary storage (e.g., a mass storage device), and removable media (e.g., flash drives, memory cards, compact discs, and digital video disc), to name just a few. Examples of the data store 106 also include virtual memory, which leverages underlying secondary storage of a computing device according to one or more memory management techniques. It is to be appreciated that the data store 106 is configurable in a variety of ways without departing from the spirit or scope of the described techniques.

As mentioned above, the controller 108 loads data into the cache 102 from the data store 106, e.g., responsive to a cache miss. In accordance with the described techniques, the controller 108 loads such data into the cache 102 based on at least one of the associativity allocator 110 or the cache replacement policy 112.

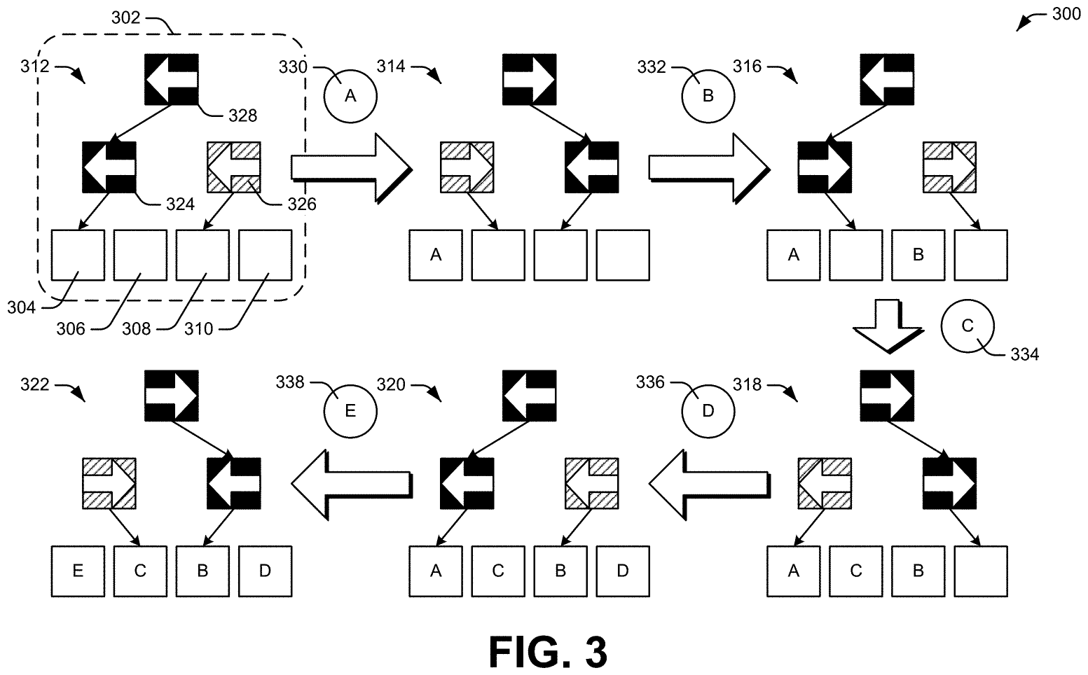

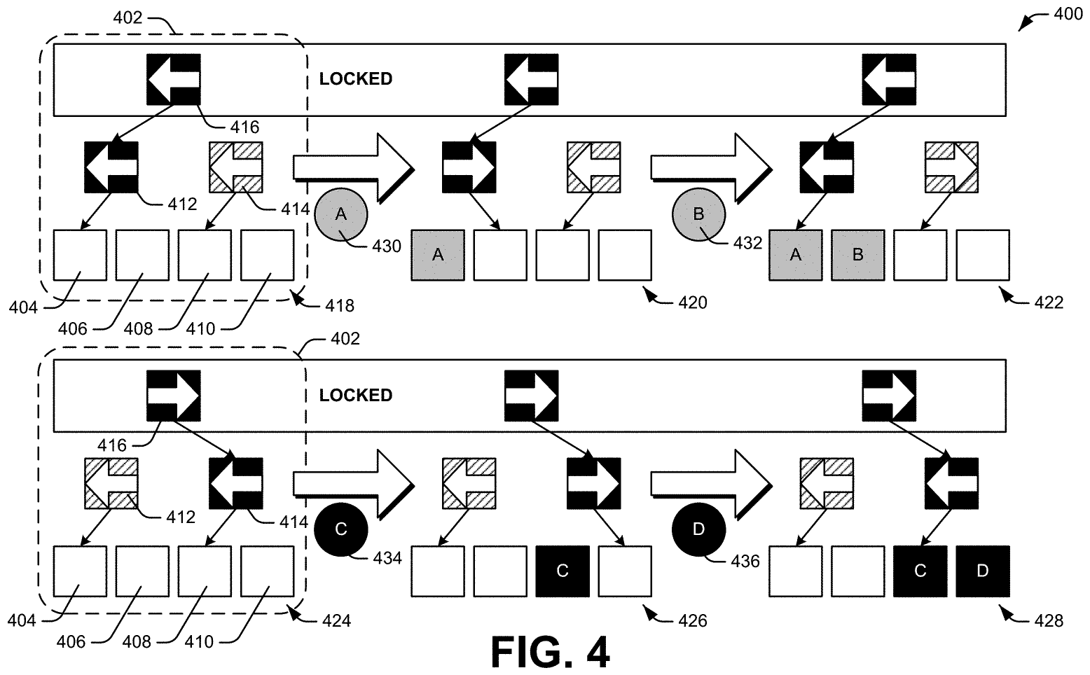

The cache replacement policy 112 controls which cachelines of the cache 102 have their data evicted and loaded with the data from the data store 106 that corresponds to the request 114, e.g., responsive to a cache miss. In one or more implementations, the cache replacement policy 112 is or includes a hardware-maintained structure that manages replacement of cachelines according to an underlying algorithm. Alternatively or in addition, the cache replacement policy 112 is or includes a computer program that manages replacement of the cachelines according to the underlying algorithm. Example cache replacement polices include, but are not limited to, first in first out, last in first out, least recently used, time-aware least recently used, most recently used, pseudo least recently used, random replacement, segmented least recently used, least-frequently used, least frequently recently used, and least frequently used with dynamic aging, to name just a few. Example implementations, in which the cache replacement policy 112 is configured at least partially according to a pseudo least recently used algorithm, are discussed in more detail in relation to FIGS. 3 and 4.

The associativity allocator 110 limits which cachelines are available to different categories of cache requests for loading data into the cache 102. In particular, the associativity allocator 110 allocates portions of associativity of the cache 102 to different categories of cache requests, such as by allocating a first portion of the associativity to a first category of cache requests and a second portion of the associativity to a second category of cache requests. In one or more implementations, the different categories correspond to different workloads or threads executed by the cache client 104. For example, a first category is associated with requests corresponding to a first workload and a second category is associated with requests corresponding to a second workload. Alternatively or additionally, categories are associated with requests based on different aspects, including but not limited to an originator or destination of a request (e.g., the request originating from a particular computing unit or being served to a local scratch memory); request characteristics (e.g., load, store, image sample, raytracing, surfaces, buffers, or shader resources); memory request policy or coherency (e.g., streaming, locally cached, or globally coherent); and request age or forced forward progress flag (e.g., when a given request stream is stalled with an out-of-order cache for an amount of time due to an independent request stream, the given request stream is isolatable to ensure forward progress), to name just a few. It is to be appreciated that the associativity allocator 110 allocates portions of associativity of the cache 102 to different numbers of categories of requests in various implementations. For example, in some variations, the associativity allocator 110 allocates a portion of the associativity to a single category of cache requests. In another example, the associativity allocator 110 allocates portions of the associativity to two or more categories of cache requests.

The associativity allocator 110 allocates a portion of the associativity of the cache 102 to a category of cache requests by reserving a subset of cachelines of the cache 102 for the category, such that the data from the data store 106 corresponding to the category is loaded into the cachelines of the subset. Given an additional category of cache requests, the associativity allocator 110 allocates an additional portion of the associativity to the additional category by reserving an additional subset of cachelines for the additional category. The data from the data store 106 that corresponds to the additional category is loaded into the cachelines of this additional subset. Thus, for multiple categories of cache requests, the associativity allocator 110 divides the associativity of the cache 102 into at least two portions, where each portion of the associativity corresponds to a respective subset of cachelines of the cache 102.

In accordance with the described techniques, associativity defines a set of cachelines of the cache 102 that data, at a location in the data store 106, is permitted to be loaded into, e.g., responsive to a cache miss. In one or more implementations, for instance, the cache 102 is fully associative, which means that the cache 102 permits data at the location in the data store 106 to be loaded into any cacheline of the cache 102. In such implementations, the set of cachelines thus corresponds to all the cachelines of the cache 102.

By allocating portions of the associativity to categories of cache requests, though, the associativity allocator 110 further limits which cachelines of the defined set of cachelines that data at the location in the data store 106 is permitted to be loaded into based on a category of the request associated with the data, e.g., a workload to which the request corresponds. The associativity allocator 110 thus permits the data at the location in the data store 106 to be loaded into a subset of the defined set of cachelines based on the category of the request. By further limiting which cachelines of the defined set that data at different locations in the data store 106 is permitted to be loaded into based on category, the associativity allocator 110 prevents a particular category of cache requests from dominating use of all the cachelines of the defined set, which is otherwise permitted given the associativity, e.g., of the cache 102. When used in connection with an out-of-order cache, for instance, the associativity allocated by the associativity allocator 110 improves forward progress of requests, whereas in some conventional techniques request streams are able to dominate out-of-order caches and starve out other request streams. Allocating associativity of the cache as described above and below also isolates cache impacts of multi-threading for deterministic behaviors associated with tuning and debugging operations.

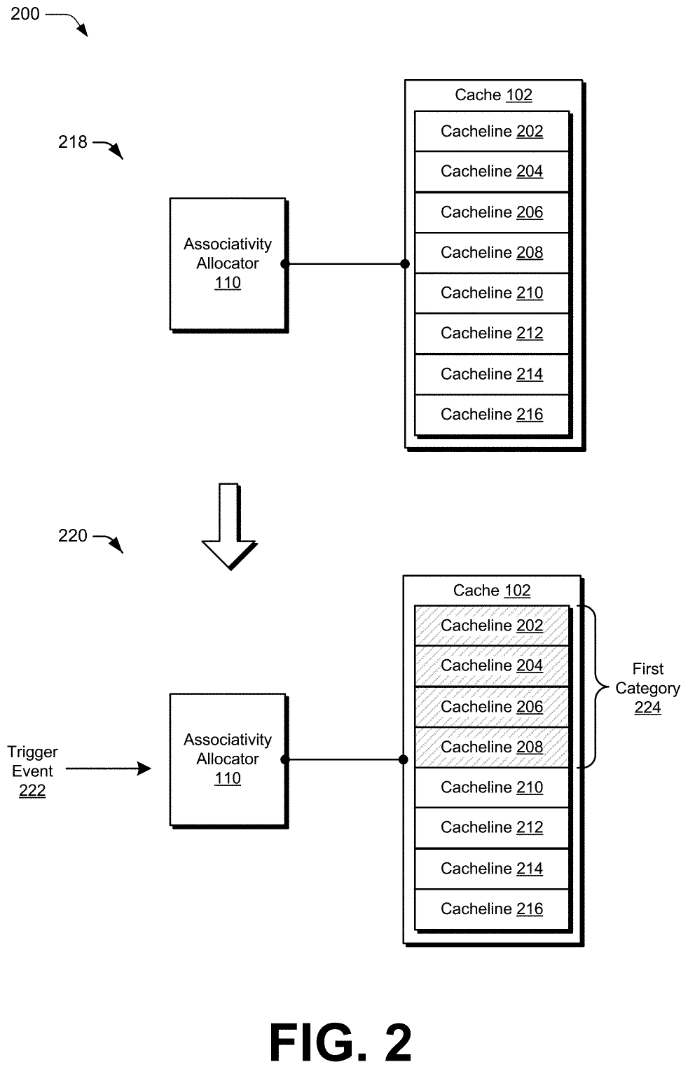

In one or more implementations, the associativity allocator 110 does not limit which cachelines the controller 108 searches based on the request 114 to determine whether the data identified by the request 114 is stored in the cache 102, e.g., to detect a cache miss or a cache hit. Rather, the associativity allocator 110 limits which cachelines the controller 108 is permitted, using the cache replacement policy 112, to evict data from and load data into in connection with cache misses. For example, the controller 108 determines a category associated with the request 114. Due to the portion of associativity allocated to the category, the associativity allocator 110 limits which cachelines are available for allocation to the data corresponding to the request 114. In the context of allocating a portion of associativity of the cache to a category of cache requests, consider the following discussion of FIG. 2.

FIG. 2 depicts a non-limiting example 200 in which an associativity allocator allocates a portion of associativity of the cache to a category of cache requests. The example 200 includes from FIG. 1 the cache 102 and the associativity allocator 110.

In this example 200, the cache 102 includes cachelines 202-216. Although the cache 102 is depicted having eight cachelines in the illustrated example 200, it is to be appreciated that the cache 102 includes different numbers of cachelines in various implementations without departing from the described techniques.

The example 200 depicts the associativity allocator 110 and the cache 102 at a first stage 218 and a second stage 220, where the second stage 220 corresponds to a time subsequent to a time that corresponds to the first stage 218. The first stage 218 depicts the cache 102 prior to a time when the associativity allocator 110 allocates a portion of associativity of the cache 102 to a category of cache requests.

The example 200 includes a trigger event 222 at the second stage 220. The trigger event 222 corresponds to at least one of a variety of events and triggers the associativity allocator 110 to allocate a portion of the associativity of the cache 102 to a category of cache requests. Examples of the trigger event 222 include, but are not limited to, launching an application and/or a process for execution via the cache client 104; initializing or launching an additional workload or thread (e.g., while a workload or thread is executing via the cache client 104); determining that requests associated with a category of cache requests are dominating use of the cachelines of a defined set (e.g., cachelines 202-216) such that performance related to requests associated with an additional category of cache requests is likely to degrade; determining that usage of the cache 102 exceeds a threshold usage (e.g., a frequency of use threshold, a threshold number of stalls, a threshold number of cache misses per time interval); determined real-time performance feedback (e.g., hit/miss rate); or a response to a hardware event (e.g., thrown exception); to name just a few. Another example of a trigger event 222 is a triggering by software, which initiates allocation of the associativity by the software (e.g., directly from an application or based on feedback from compilation and/or a driver). In various implementations, for instance, software triggers allocation of the associativity for tuning and/or balancing, and the associativity is allocated according to a programmed combination of categories for a single workload (or thread) or for a plurality of workloads (or threads). Additional, example trigger events 222 include execution of unrelated workloads together (e.g., such as during virtualization when independent workloads share a single computing unit without knowledge of the other workload) and receipt by the controller 108 of a category (e.g., a “new” category). It is to be appreciated that different trigger events cause the associativity allocator 110 to allocate a portion of associativity of the cache 102 to a category of cache requests in various implementations.

Based on the trigger event 222, the associativity allocator 110 allocates the associativity of the cache 102, in part, by dividing the associativity into at least a first portion and a second portion. In this example 200, for instance, the cache 102 is fully associative with respect to the set of cachelines 202-216. This means that the cache 102 permits data from a location in the data store 106 to be loaded into any of the cachelines 202-216 at the first stage 218, e.g., responsive to a cache miss. In accordance with the described techniques, the associativity allocator 110 divides the associativity of the cache 102 based on the trigger event 222 into a first portion which corresponds to a first subset of cachelines (e.g., the cachelines 202, 204, 206, 208) of the cache 102 and a second portion which corresponds to a second subset of cachelines (e.g., the cachelines 210, 212, 214, 216) of the cache 102.

Once the associativity is divided, the associativity allocator 110 allocates the first portion of associativity to a first category 224 of cache requests. As a result, rather than permitting the controller 108 to load data that corresponds to the first category 224 of cache requests into any of the cachelines 202-216, as is permitted by the associativity of the cache 102, the associativity allocator 110 limits the controller 108 to loading such data into the cachelines 202-208. In one or more implementations, the associativity allocator 110 also allocates the second portion of associativity to a second category of cache requests (not shown). In such implementations, the associativity allocator 110 limits the controller 108 to loading data that corresponds to the second category of cache requests into the cachelines 210-216, rather than permitting the controller 108 to load that data into any of the cachelines 202-216, as is permitted by the associativity of the cache 102.

In various implementations, the associativity allocator 110 divides the associativity in different ways. For example, in at least one scenario involving two categories of cache requests (e.g., a first category of requests corresponding to a first workload or thread and a second category of requests corresponding to a second workload or thread), the associativity allocator 110 divides the associativity of the cache 102 into two portions, such as equal portions where the first category of requests are limited to having their respective data loaded into half of the cachelines and where the second category of requests are limited to having their respective data loaded into the other half of the cachelines.

In another example, the associativity allocator 110 divides the associativity of the cache 102 into four portions, such as in a scenario involving four categories of cache requests, e.g., a first category of requests corresponding to a first workload or thread; a second category of requests corresponding to a second workload or thread; a third category of requests corresponding to a third workload or thread; and a fourth category of requests corresponding to a fourth workload or thread. In at least one such scenario, the associativity allocator 110 divides the associativity evenly by limiting each category to loading its data into a respective quarter of the cachelines. It is to be appreciated, however, that in one or more scenarios, the associativity allocator 110 does not divide the associativity evenly among the categories of cache requests, such as in at least one scenario involving three categories of cache requests. Although various divisions of associativity are discussed above, the associativity allocator 110 is configured to divide and allocate associativity of a set of cachelines in different ways without departing from the described techniques.

By allocating a portion of associativity to a category, the associativity allocator 110 limits which cachelines the cache replacement policy 112 is permitted to select for evicting and loading data that corresponds to the category, e.g., responsive to a cache miss. For a given request, for instance, the cache replacement policy 112 is limited to selecting a cacheline in a subset of cachelines reserved for a category corresponding to the request. In this context, consider the following discussion of FIGS. 3 and 4.

FIG. 3 depicts a non-limiting example 300 in which a tree structure of a cache replacement policy is traversed according to a traversal algorithm of the cache replacement policy to select cachelines.

The illustrated example 300 includes tree structure 302. In this example 300, the tree structure is a binary tree. In other examples, however, the cache replacement policy 112 is implemented using other tree structures or no tree structure. As illustrated, the tree structure 302 includes leaf nodes 304, 306, 308, 310. As described herein, the “leaf nodes” correspond to nodes in a binary tree which do not have any child nodes. The leaf nodes 304, 306, 308, and 310 correspond to cachelines of the cache 102. By way of example, the leaf node 304 corresponds to the cacheline 202, the leaf node 306 corresponds to the cacheline 204, the leaf node 308 corresponds to the cacheline 206, and the leaf node 310 corresponds to the cacheline 208. In scenarios where the traversal algorithm of the cache replacement policy 112 is not prevented from selecting any of the cachelines which correspond to the leaf nodes 304-310—such as due to one or more cachelines being non-replaceable or due to constraints on the associativity—the traversal algorithm simply causes the tree structure to be traversed according to a respective set of rules to select a cacheline for eviction and loading data.

In the illustrated example 300, the traversal algorithm is depicted traversing the tree structure 302 at multiple stages and selecting a cacheline for eviction and loading at each stage. The depicted stages include first stage 312, second stage 314, third stage 316, fourth stage 318, fifth stage 320, and sixth stage 322. In particular, the multiple stages 312-322 depict traversal of the tree according to a pseudo least recently used algorithm, which is one example of a traversal algorithm for traversing a binary tree. As noted above, in various implementations the cache replacement policy 112 is configured based on different algorithms without departing from the spirit or scope of the described techniques.

In accordance with pseudo least recently used, each node of the tree structure 302 includes or is otherwise associated with a traversal direction indicator that indicates a direction of traversal down the tree structure from the node to a child node, e.g., the indicator indicates whether the traversal is to proceed from the node to a left child node or to a right child node. If during a traversal the node is traversed, the indicator of direction is switched to indicate the other direction for a subsequent traversal, e.g., if the indicator of a node indicates to proceed to the left child node prior to a traversal and the node is traversed during the traversal (e.g., by proceeding as directed by the indicator from the node to the left child node), then the indicator is switched to indicate to proceed from the node to the right child node the next time the node is traversed, and vice-versa.

In addition to the leaf nodes 304-310, the tree structure 302 in this example 300 also includes nodes 324, 326, 328. As tree structure 302 is a binary tree, each node (other than the leaf nodes) has two child nodes. In this example, node 324 and node 326 are “child” nodes of node 328, which is thus a “parent” of node 324 and node 326. Similarly, leaf nodes 304 and 306 are “child” nodes of node 324 (which is thus a “parent” of leaf nodes 304 and 306) and leaf nodes 308 and 310 are “child” nodes of node 326 (which is thus a parent of leaf nodes 308 and 310).

In this example, each of the nodes 324, 326, 328 is illustrated with a graphical representation of a respective traversal direction indicator. At the first stage 312, for instance, the graphical representations indicate that the traversal direction indicator of the node 328 directs the algorithm to the left if the node 328 is traversed, the traversal direction indicator of the node 324 directs the algorithm to the left if the node 324 is traversed, and the traversal direction indicator of the node 326 directs the algorithm to the left if the node 326 is traversed. As noted above, according to pseudo least recently used, if a node is traversed during a traversal, then the traversal direction indicator of the node is switched, e.g., from pointing to the left child node to the right or from pointing to the right child node to the left.

To traverse the tree structure 302 according to pseudo least recently used, the traversal algorithm of the cache replacement policy 112 begins at the root node, i.e., node 328. At the first stage 312, the traversal direction indicator of the node 328 directs the traversal algorithm to proceed from the node 328 to its left child node, i.e., node 324. The traversal algorithm thus traverses the node 324. The traversal direction indicator of the node 324 directs the traversal algorithm to proceed from the node 324 to its left child node, i.e., leaf node 304 which corresponds to the cacheline 202 in this example. Since the child node of the node 324 is a leaf node, the algorithm stops at the leaf node 304, and thus selects the cacheline corresponding to the leaf node 304 for having data evicted and new data loaded from the data store 106. In the illustrated example 300, data store data 330 (graphically represented as ‘A’) is thus loaded into the cacheline 202. Responsive to the traversal to evict data and load the data store data 330, the traversal direction indicators of traversed nodes are switched. Since the nodes 324, 328 are traversed in order to evict data and load the data store data 330, the traversal indicators of those nodes are switched from directing the algorithm to the left to directing the algorithm to the right. Since the node 326 is not traversed at the first stage 312, the traversal indicator of the node 326 is not switched—it remains directing the algorithm to the left.

Thus, at the second stage 314, the graphical representations of the respective traversal direction indicators indicate that the traversal direction indicator of the node 328 directs the algorithm to the right if the node 328 is traversed, the traversal direction indicator of the node 324 directs the algorithm to the right if the node 324 is traversed, and the traversal direction indicator of the node 326 directs the algorithm to the left if the node 326 is traversed. At the second stage 314, the traversal algorithm of the cache replacement policy 112 begins traversing the tree structure 302 at the root node, i.e., node 328. At the second stage 314, the traversal direction indicator of the node 328 directs the traversal algorithm to proceed from the node 328 to its right child node, i.e., node 326. The traversal algorithm thus traverses the node 326. The traversal direction indicator of the node 326 directs the traversal algorithm to proceed from the node 326 to its left child node, i.e., the leaf node 308 which corresponds to the cacheline 206 in this example.

Since the child node of the node 326 is a leaf node, the algorithm stops at the leaf node 308, and thus selects the cacheline corresponding to the leaf node 308 for having data evicted and new data loaded from the data store 106. In the illustrated example 300, data store data 332 (graphically represented as T′) is thus loaded into the cacheline 206. Responsive to the traversal to evict data and load the data store data 332, the traversal direction indicators of traversed nodes are switched. Since the nodes 326, 328 are traversed in order to evict data and load the data store data 332, the traversal direction indicators of those nodes are switched. Specifically, the traversal direction indicator of the node 328 is switched from directing the algorithm to the right to directing the algorithm to the left, and the traversal direction indicator of the node 326 is switched from directing the algorithm to the left to directing the algorithm to the right. Since the node 324 is not traversed at the second stage 314, the traversal indicator of the node 324 is not switched—it remains directing the algorithm to the right.

Thus, at the third stage 316, the graphical representations indicate that the traversal direction indicator of the node 328 directs the algorithm to the left if the node 328 is traversed, the traversal direction indicator of the node 324 directs the algorithm to the right if the node 324 is traversed, and the traversal direction indicator of the node 326 directs the algorithm to the right if the node 326 is traversed. At the third stage 316, the traversal algorithm of the cache replacement policy 112 begins traversing the tree structure 302 at the root node, i.e., node 328. At the third stage 316, the traversal direction indicator of the node 328 directs the traversal algorithm to proceed from the node 328 to its left child node, i.e., node 324. The traversal algorithm thus traverses the node 324. The traversal direction indicator of the node 324 directs the traversal algorithm to proceed from the node 324 to its right child node, i.e., the leaf node 306 which corresponds to the cacheline 204 in this example.

Since the child node of the node 324 is a leaf node, the algorithm stops at the leaf node 306, and thus selects the cacheline corresponding to the leaf node 306 for having data evicted and new data loaded from the data store 106. In the illustrated example 300, data store data 334 (graphically represented as ‘C’) is thus loaded into the cacheline 204. Responsive to the traversal to evict data and load the data store data 334, the traversal direction indicators of traversed nodes are switched. Since the nodes 324, 328 are traversed in order to evict data and load the data store data 334, the traversal direction indicators of those nodes are switched. Specifically, the traversal direction indicator of the node 328 is switched from directing the algorithm to the left to directing the algorithm to the right, and the traversal direction indicator of the node 324 is switched from directing the algorithm to the right to directing the algorithm to the left. Since the node 326 is not traversed at the third stage 316, the traversal indicator of the node 326 is not switched—it remains directing the algorithm to the right.

The traversal algorithm of the cache replacement policy 112 continues traversing the tree structure 302 of the cache replacement policy 112 according to the traversal direction indicators and continues switching the indicators of traversed nodes over the fourth, fifth, and sixth stages 318, 320, 322, respectively. In connection with such traversals, the cache replacement policy 112 further directs eviction of data and loading of data store data 336 (graphically represented as ‘D’) and of data store data 338 (graphically represented as ‘E’) into the cachelines corresponding to the illustrated leaf nodes. In the context of modifying the cache replacement policy 112 to allocate portions of associativity to different categories of cache requests, consider the following discussion.

FIG. 4 depicts a non-limiting example 400 of an implementation in which the cache replacement policy is modified to allocate a portion of associativity of the cache to a category of cache requests. In the illustrated example 400, the associativity allocator 110 modifies the traversal algorithm of the cache replacement policy 112, in part, to allocate portions of associativity of the cache 102 to two categories of cache requests.

The illustrated example 400 includes tree structure 402. In this example, the tree structure is a binary tree, although the cache replacement policy is implemented using other tree structures or no tree structure in various implementations. As illustrated, the tree structure includes leaf nodes 404, 406, 408, 410 and nodes 412, 414, 416. The leaf nodes 404-410 correspond to cachelines of the cache 102. By way of example, the leaf node 404 corresponds to the cacheline 202, the leaf node 406 corresponds to the cacheline 204, the leaf node 408 corresponds to the cacheline 206, and the leaf node 410 corresponds to the cacheline 208. The leaf nodes 404-410 are “child” nodes of the node 412 and the node 414. Further, the node 412 and the node 414 are “child” nodes of node 416, which is thus a “parent” of node 412 and node 414.

In example 400, the associativity allocator 110 allocates associativity of the cache 102 to categories of cache requests by modifying the traversal algorithm, used to traverse the tree structure 402, at a particular node of the tree structure 402. In this example, the associativity allocator 110 modifies the traversal algorithm at the node 416 but does not modify the traversal algorithm at other nodes of the tree structure 402. In variations though, the associativity allocator 110 modifies traversal algorithms at more than one node or modifies traversal algorithms in different ways to allocate associativity without departing from the spirit or scope of the described techniques. For example, in some variations, the associativity allocator 110 modifies the traversal algorithm at multiple nodes across a same level of a tree structure.

In this example 400, the traversal algorithm of the cache replacement policy 112 is pseudo least recently used, details of which are discussed more above in relation to FIG. 3. The associativity allocator 110 allocates a first portion of associativity of the cache 102 to a first category of requests (e.g., corresponding to a first workload or thread) and allocates a second portion of associativity of the cache 102 to a second category of requests (e.g., corresponding to a second workload or thread). To allocate portions of the associativity to the categories, in this example 400, the associativity allocator 110 modifies the traversal algorithm by “locking,” or otherwise setting, the traversal direction indicator of the node 416 in a first direction for the first category of requests (e.g., left) and a second direction for the second category of requests (e.g., right).

By locking the traversal direction indicator of the node 416 in different directions for the first and second categories of requests, the associativity allocator 110 limits the traversal algorithm of the cache replacement policy 112 to selecting the cachelines 202, 204 for the first category, which correspond to the leaf nodes 404, 406, respectively. The associativity allocator 110 further limits the traversal algorithm to selecting the cachelines 206, 208 for the second category, which correspond to the leaf nodes 408, 410, respectively. In this way, the associativity allocator reserves half of the associativity (corresponding to cachelines 202 and 204) to the first category of cache requests and the other half of the associativity (corresponding to cachelines 206 and 208) to the second category of cache requests.

To illustrate this, the example 400 includes a first series of stages 418, 420, 422, where the traversal direction indicator of the node 416 is locked pointing to the left for requests that correspond to the first category. The example 400 also includes a second series of stages 424, 426, 428, where the traversal direction indicator of the node 416 is locked pointing to the right for requests that correspond to the second category.

In this example 400, data store data 430 (graphically represented as ‘A’) and data store data 432 (graphically represented as ‘B’) correspond to a first category of cache requests. For instance, the data store data 430 corresponds to a request to access the cache 102 that resulted in a cache miss, where the request is associated with a first category, such as with a first workload or thread. Further, the data store data 432 corresponds to an additional request to access the cache 102 that resulted in a cache miss, where the additional request is also associated with the first category, such as with the first workload or thread.

At the first stage 418 of the first series, the cache replacement policy 112 begins traversing the tree structure 402 at the root node, i.e., the node 416. Since the associativity allocator 110 has modified the traversal algorithm at the node 416 by locking its traversal direction indicator to the left for the first category, the traversal algorithm proceeds from the node 416 to its left child node, i.e., node 412. The traversal algorithm thus traverses the node 412. Since the node 412 is not locked, the node 412 is traversed according to the unmodified traversal algorithm—according to pseudo least recently used in this example. The traversal direction indicator of the node 412 directs the traversal algorithm to proceed from the node 412 to its left child node, i.e., leaf node 404 which corresponds to the cacheline 202 in this example. Since the child node of the node 412 is a leaf node, the algorithm stops at the leaf node 404, and thus selects the cacheline corresponding to the leaf node 404 for having data evicted and new data loaded from the data store 106.

In the illustrated example 400, the data store data 430 is thus loaded into the cacheline 202. Responsive to the traversal to evict data and load the data store data 430, the traversal direction indicators of traversed nodes are switched according to pseudo least recently used. Since the node 412 is traversed in order to evict data and load the data store data 430, the traversal indicator of the node 412 is switched from directing the algorithm to the left to directing the algorithm to the right. Since the node 416 is locked by the associativity allocator 110, the traversal direction indicator of the node 416 is not switched—it remains directing traversals related to requests of the first category to the left.

At the second stage 420 of the first series, the cache replacement policy 112 begins traversing the tree structure 402 at the root node, i.e., the node 416. Because the traversal direction indicator of the node 416 is locked to the left, the traversal algorithm proceeds from the node 416 to its left child node, i.e., node 412. The traversal algorithm thus traverses the node 412. As noted above, the node 412 is not locked and its traversal direction indicator is switched due to traversal at the first stage 418 to direct the algorithm to the right in a subsequent traverse. As a result, at the second stage 420, the traversal direction indicator of the node 412 directs the traversal algorithm to proceed from the node 412 to its right child node, i.e., leaf node 406 which corresponds to the cacheline 204 in this example. Since this child node of the node 412 is a leaf node, the algorithm stops at the leaf node 406, and thus selects the cacheline corresponding to the leaf node 406 for having data evicted and new data loaded from the data store 106.

In the illustrated example 400, the data store data 432 is thus loaded into the cacheline 204. Responsive to the traversal to evict data and load the data store data 432, the traversal direction indicators of traversed nodes are switched according to pseudo least recently used. Since the node 412 is traversed in order to evict data and load the data store data 432, the traversal indicator of the node 412 is switched from directing the algorithm to the right to directing the algorithm to the left, as depicted in the third stage 422 of the first series Since the node 416 is locked by the associativity allocator 110, the traversal direction indicator of the node 416 is not switched—it remains directing traversals related to requests of the first category to the left.

By contrast, data store data 434 (graphically represented as ‘C’) and data store data 436 (graphically represented as TY) correspond to a second category of cache requests. For instance, the data store data 434 corresponds to a request to access the cache 102 that resulted in a cache miss, where the request is associated with a second category, such as with a second workload or thread. Further, the data store data 436 corresponds to an additional request to access the cache 102 that resulted in a cache miss, where the additional request is also associated with the second category, such as with the second workload or thread.

At the first stage 424 of the second series, the cache replacement policy 112 begins traversing the tree structure 402 at the root node, i.e., the node 416. Since the associativity allocator 110 has modified the traversal algorithm at the node 416 by locking its traversal direction indicator to the right for the second category, the traversal algorithm proceeds from the node 416 to its right child node, i.e., node 414. The traversal algorithm thus traverses the node 414. Since the node 414 is not locked, the node 414 is traversed according to the unmodified traversal algorithm—according to pseudo least recently used in this example. The traversal direction indicator of the node 414 directs the traversal algorithm to proceed from the node 414 to its left child node, i.e., leaf node 408 which corresponds to the cacheline 206 in this example. Since the child node of the node 414 is a leaf node, the algorithm stops at the leaf node 408, and thus selects the cacheline corresponding to the leaf node 408 for having data evicted and new data loaded from the data store 106.

In the illustrated example 400, the data store data 434 is thus loaded into the cacheline 206. Responsive to the traversal to evict data and load the data store data 434, the traversal direction indicators of traversed nodes are switched according to pseudo least recently used. Since the node 414 is traversed in order to evict data and load the data store data 434, the traversal indicator of the node 414 is switched from directing the algorithm to the left to directing the algorithm to the right. Since the node 416 is locked by the associativity allocator 110, the traversal direction indicator of the node 416 is not switched—it remains directing traversals related to requests of the second category to the right.

At the second stage 426 of the second series, the cache replacement policy 112 begins traversing the tree structure 402 at the root node, i.e., the node 416. Because the traversal direction indicator of the node 416 is locked to the right for the second category, the traversal algorithm proceeds from the node 416 to its right child node, i.e., node 414. The traversal algorithm thus traverses the node 414. As noted above, the node 414 is not locked and its traversal direction indicator is switched due to traversal at the first stage 424 to direct the algorithm to the right in a subsequent traverse. As a result, at the second stage 426, the traversal direction indicator of the node 414 directs the traversal algorithm to proceed from the node 414 to its right child node, i.e., leaf node 410 which corresponds to the cacheline 208 in this example. Since this child node of the node 414 is a leaf node, the algorithm stops at the leaf node 410, and thus selects the cacheline corresponding to the leaf node 410 for having data evicted and new data loaded from the data store 106.

In the illustrated example 400, the data store data 436 is thus loaded into the cacheline 208. Responsive to the traversal to evict data and load the data store data 436, the traversal direction indicators of traversed nodes are switched according to pseudo least recently used. Since the node 414 is traversed in order to evict data and load the data store data 436, the traversal indicator of the node 414 is switched from directing the algorithm to the right to directing the algorithm to the left, as depicted in the third stage 428 of the second series Since the node 416 is locked by the associativity allocator 110, the traversal direction indicator of the node 416 is not switched—it remains directing traversals related to requests of the first category to the left.

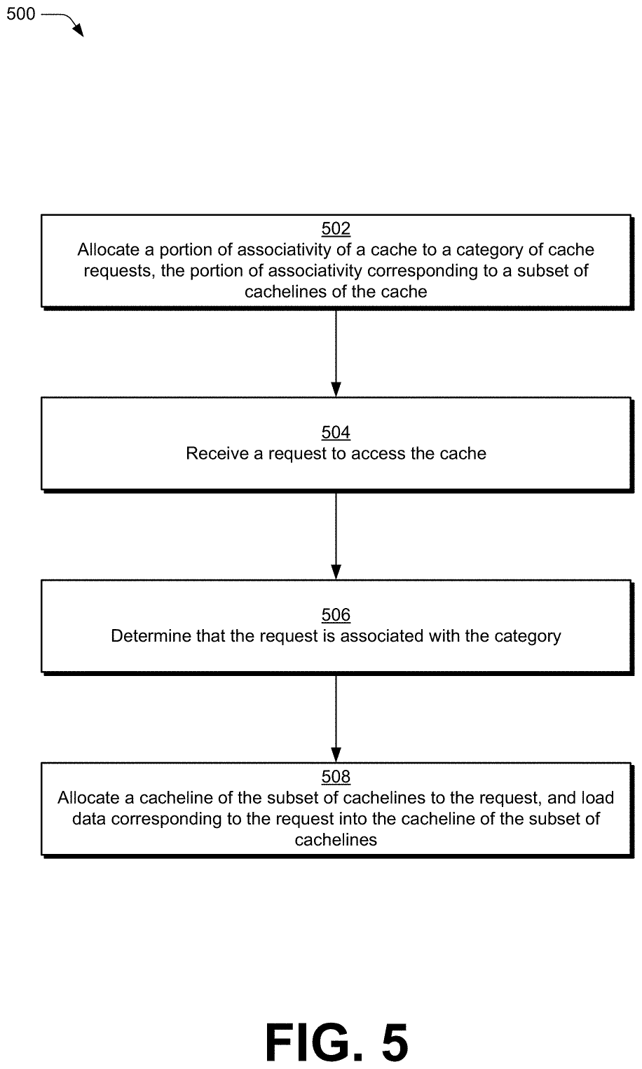

FIG. 5 depicts a procedure 500 in an example implementation of allocating a portion of associativity of a cache to a category of cache requests.

A portion of associativity of a cache is allocated to a category of cache requests (block 502). In accordance with the principles discussed herein, the portion of associativity corresponds to a subset of cachelines of the cache. By way of example, the associativity allocator 110 allocates a portion of the associativity of the cache 102 to a category of cache requests by reserving a subset of cachelines of the cache 102 for the category, such that the data from the data store 106 corresponding to the category is loaded into the cachelines of the subset. As an example, the associativity allocator 110 allocates a first portion of associativity of cache 102 to a first category 224 of cache requests. The first portion of associativity of the cache 102, for example, corresponds to cachelines 202-208. By allocating the first portion of associativity of the cache 102 to the first category 224, the associativity allocator 110 limits the controller 108 to loading data associated with subsequent cache requests by the first category 224 into the cachelines 202-208.

A request to access the cache is received (block 504), and it is determined that the request is associated with the category (block 506). By way of example, the controller 108 receives a request 114 to access the cache 102, and the controller 108 determines a category associated with the request 114. For instance, the controller 108 determines that the request 114 is associated with the first category 224.

A cacheline of the subset of cachelines is allocated to the request and data corresponding to the request is loaded into the cacheline of the subset of cachelines (block 508). By way of example, if the controller 108 determines that the request 114 is associated with the first category 224 of cache requests, then data store data 120 corresponding to the request 114 is loaded into one of the cachelines 202-208 of the cache 102, which have been allocated to the first category 224 of cache requests by the associativity allocator.

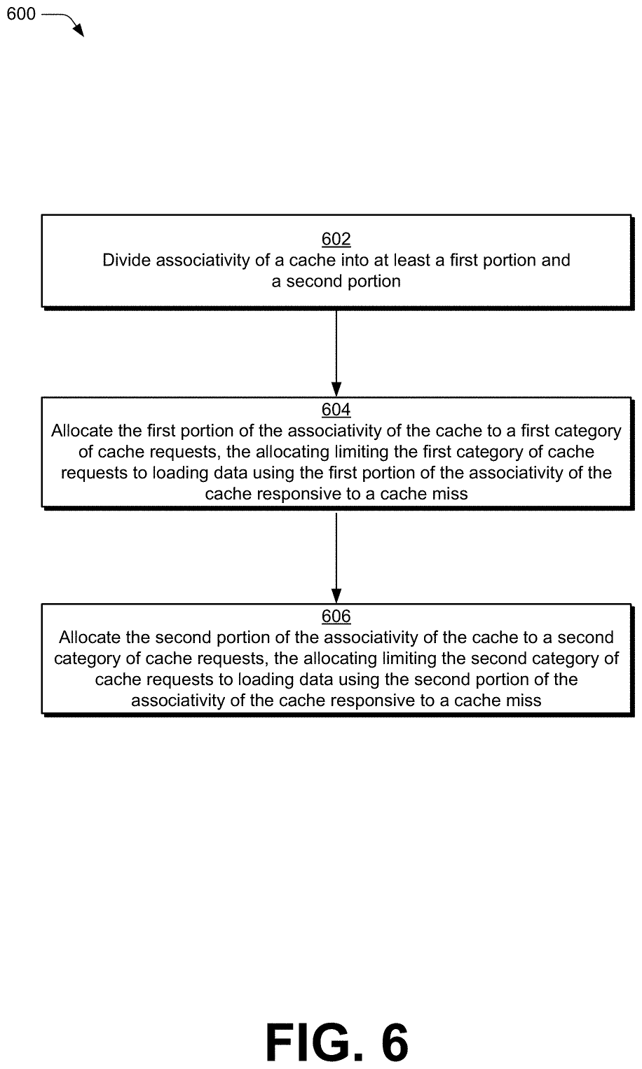

FIG. 6 depicts a procedure 600 in an example implementation of dividing associativity of a cache and allocating portions of associativity of the cache to different categories of cache requests.

Associativity of a cache is divided into at least a first portion and a second portion (block 602). By way of example, the associativity allocator 110 divides the associativity of the cache 102 into a first portion which corresponds to a first subset of cachelines (e.g., the cachelines 202, 204, 206, 208) of the cache 102 and a second portion which corresponds to a second subset of cachelines (e.g., the cachelines 210, 212, 214, 216) of the cache 102.

The first portion of the associativity of the cache is allocated to a first category of cache requests (block 604). In accordance with the principles discussed here, the allocating limits the first category of cache requests to loading data using the first portion of the associativity of the cache responsive to a cache miss. By way of example, once the associativity is divided, the associativity allocator 110 allocates the first portion of associativity of the cache 102 to a first category 224 of cache requests. As a result, rather than permitting the controller 108 to load data that corresponds to the first category 224 of cache requests into any of the cachelines 202-216, as is permitted by the associativity of the cache 102, the associativity allocator 110 limits the controller 108 to loading such data using the first portion of the associativity of the cache 102 which corresponds to cachelines 202, 204, 206, and 208.

The second portion of associativity of the cache is allocated to the second category of cache requests (block 606). In accordance with the principles discussed herein, the allocating limits the second category of cache requests to loading data using the second portion of the associativity of the cache responsive to the cache miss. By way of example, the associativity allocator 110 also allocates the second portion of associativity to a second category of cache requests. In such implementations, the associativity allocator 110 limits the controller 108 to loading data that corresponds to the second category of cache requests into the cachelines 210-216, rather than permitting the controller 108 to load that data into any of the cachelines 202-216, as is permitted by the associativity of the cache 102.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the cache 102, the cache client 104, the data store 106, the controller 108, the associativity allocator 110, and the cache replacement policy 112) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method comprising:
allocating a portion of associativity of a cache to a category of cache requests, the portion of associativity corresponding to a subset of cachelines of the cache;
receiving a request to access the cache; and
allocating a cacheline of the subset of cachelines to the request based on a category associated with the request, and loading data corresponding to the request into the cacheline of the subset of cachelines.

2. The method of claim 1, wherein the allocating the portion of the associativity comprises locking traversal of at least one node of a tree structure in a direction, the tree structure traversed to identify which cachelines to allocate to requests, and the traversal being locked in the direction for requests associated with the category.

3. The method of claim 2, further comprising allocating an additional portion of the associativity of the cache to an additional category of cache requests, the additional portion of the associativity allocated by locking the traversal of the at least one node of the tree structure in a different direction for requests associated with the additional category.

4. The method of claim 2, wherein the tree structure is a binary tree that is traversed according to a pseudo least recently used algorithm to identify which cachelines to allocate to the requests.

5. The method of claim 2, further comprising allocating the cacheline of the subset of cachelines, and loading the data corresponding to the request by traversing the tree structure.

6. The method of claim 1, further comprising:
allocating an additional portion of the associativity of the cache to an additional category of cache requests, the additional portion of associativity corresponding to an additional subset of cachelines of the cache;
receiving an additional request associated with the additional category to access the cache; and
allocating a cacheline of the additional subset of cachelines to the additional request and loading additional data corresponding to the additional request into the cacheline of the additional subset of cachelines.

7. The method of claim 6, wherein the category corresponds to a first workload or thread and wherein the additional category corresponds to a second workload or thread.

8. The method of claim 1, further comprising determining that the category associated with the request corresponds to the category of cache requests.

9. The method of claim 1, wherein the category of cache requests is associated with at least one of:
a workload or thread of with the cache requests;
an originator of the cache requests;
a destination of the cache requests; or
characteristics of the cache requests.

10. The method of claim 1, wherein allocating the portion of associativity of the cache to the category of cache requests occurs responsive to a trigger event, the trigger event comprising one of:
launching an application;
initializing a workload or thread; or
determining that usage of the cache exceeds a threshold usage.

11. The method of claim 1, wherein the data corresponding to the request is obtained from a data store.

12. The method of claim 11, wherein the data store comprises a virtual memory.

13. A system comprising:
a cache divided into cachelines; and
a controller to:
allocate a portion of associativity of the cache to a category of cache requests, the portion of associativity corresponding to a subset of the cachelines; and
allocate a cacheline of the subset of cachelines to a request based on a category of the request, and load data corresponding to the request into the cacheline of the subset of cachelines.

14. The system of claim 13, wherein the controller allocates the portion of associativity of the cache by locking traversal of at least one node of a tree structure in a direction, the tree structure traversed to identify which cachelines to allocate to requests, and the traversal being locked in the direction for requests associated with the category.

15. The system of claim 14, wherein the controller is further configured to allocate an additional portion of the associativity of the cache to an additional category of cache requests, the additional portion of the associativity allocated by locking the traversal of the at least one node of the tree structure in a different direction for requests associated with the additional category.

16. The system of claim 15, wherein the tree structure is a binary tree that is traversed according to a pseudo least recently used algorithm to identify which cachelines to allocate to the requests.

17. The system of claim 13, wherein the cache is connected to an external memory.

18. The system of claim 13, wherein the system comprises a server, a personal computer, or a mobile device.

19. A method comprising:
dividing associativity of a cache into at least a first portion and a second portion;
allocating the first portion of the associativity of the cache to a first category of cache requests, the allocating limiting the first category of cache requests to loading data using the first portion of the associativity of the cache responsive to a cache miss; and
allocating the second portion of the associativity of the cache to a second category of cache requests, the allocating limiting the second category of cache requests to loading data using the second portion of the associativity of the cache responsive to a cache miss.

20. The method of claim 19, wherein:
the allocating the first portion of associativity of the cache to the first category of cache requests permits the first category of cache requests to access both the first portion and the second portion of associativity of the cache but prevents the first category of cache requests from loading data using the second portion of associativity of the cache responsive to the cache miss; and
the allocating the second portion of associativity of the cache to the second category of cache requests permits the second category of cache requests to access both the first portion and the second portion of associativity of the cache but prevents the second category of cache requests from loading data using the first portion of associativity the cache responsive to the cache miss.
